(19) United States
(12) Patent Application Publication
(10) Pub. No.: US 2004/0067694 A1
(43) Pub. Date: Apr. 8, 2004

(54) Plug-socket connector applied to bus device of data-processing system

(76) Inventor: Chien-Yi Shih, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/672,459

(22) Filed: Sep. 26, 2003

(30) Foreign Application Priority Data
Oct. 4, 2002 (TW) 091215820

(51) Int. Cl. H01R 13/64

(52) U.S. Cl. 439/677

(57) ABSTRACT

A plug-socket connector for connecting a bus device of a data-processing system and a peripheral device is disclosed. The bus device includes a control chip. The plug-socket connector includes a plug element, a connection port, and a socket element. The plug includes a plurality of pins electrically connected to the control chip and arranged in an array having a vacant site wherein at least three sides of the vacant site are adjacent to other pins. The socket element includes a block and a plurality of holes arranged in the same array and respectively corresponding to the vacant site and the plurality of pins in position so that the plug element and the socket element would not be assembled in a wrong relative position.

### FIELD OF THE INVENTION

The present invention relates to a plug-socket connector, and more particularly to a plug-socket connector applied to a bus device of a data-processing system.

### BACKGROUND OF THE INVENTION

Please refer to FIG. 1(a) which is a functional block diagram showing elements associated with IEEE 1394 connection in a personal computer (PC) system. An IEEE 1394 control chip 11, a newly developed detachable bus device, is connected to the South Bridge chip 10. This bus device is advantageous due to its hot-swappable, real plug and play, and high-speed transmission features. Since the position of the IEEE 1394 port 12 on the casing is preferably variable with the requirements of different computer suppliers, the IEEE 1394 port 12 is generally connected to the main board via a plug-socket connector. The plug-socket connector includes one or more plugs 13 arranged on the main board, and corresponding socket(s) 14 wired to the IEEE 1394 port 12. FIG. 1(b) shows the conventional structure of the elements described in FIG. 1(a). The plug 13 includes a 2×5 pin array with one left undefined because only nine pins are required by the IEEE 1394 serial bus. The definition of the nine pins is as below.

TABLE 1

| | | | | | |
|---|---|---|---|---|---|
| pin | 6 | 7 | 8 | 9 | 10 |
| | PWR | TPA− | TPB− | GND | GND |
| | PWR | TPA+ | TPB+ | GND | undefined |
| pin | 1 | 2 | 3 | 4 | 5 |

The undefined pin 5 of the plug 13 and its corresponding hole of the socket 14 are generally omitted, i.e. the pin 5 is removed to form a vacant site 131 and the hole 5 is filled into a block 141 in order to prevent from misalignment of the pins of the plug 13 with the holes of the socket 14 while assembling. In other words, when the socket 14 wrongly positions the pins 1˜5 and pins 6˜10 of the plug 13 corresponding to the holes 10˜6 and holes 5˜1 of the socket 14, respectively, the insertion cannot be achieved because the hole 5 has become the block 141 and the pin 6 cannot be received by the block 141. Therefore, the mistake can be found immediately. However, if another kind of mistake is made by shiftingly positioning the pins 2˜5 and pins 7˜10 corresponding to the holes 1˜4 and holes 6˜9, respectively, as shown as FIG. 1(c), the insertion can be successfully achieved so that the mistake is possibly not found during assembling.

On the condition that the plug 13 and the socket 14 are wrongly combined, the power lines will be wrongly in contact with the signal lines. Under this circumstance, the power voltage supplied by the IEEE 1394 peripheral device 15 (for example, a digital camera) will be transmitted to the IEEE 1394 control chip 11 via the plug-socket connector. As is known, the power voltage defined by the IEEE 1394 is 12V, but the IEEE 1394 control chip 11 made by a complementary metal-oxide-semiconductor (CMOS) process can only sustain an operating voltage of 7V Therefore, a serious damage will be rendered for the IEEE 1394 control chip 11 to receive the power voltage of 12V. On the other hand, the power voltage of 12V supplied by the IEEE 1394 control chip 11 will also damage the IEEE 1394 peripheral device 15. In order to solve such problem, a shell 132 is proposed to surround the plug 13, as shown in FIG. 1(d). However, for the more and more crowded main board, the additional shell 132 increases both the difficulty of the layout and the production cost. Therefore, how to solve the problem by omitting the shell 132 becomes an important issue.

### SUMMARY OF THE INVENTION

An object of the present invention is to provide a plug-socket connector having reliable position-identifying means without any addition shell element so as to simplify the layout and reduce the production cost.

In a first aspect, the plug-socket connector in accordance with the present invention is used for the connection of a main board and a peripheral device. The plug-socket connector comprises a plug element mounted on the main board, and comprising a plurality of pins electrically connected to the control chip and arranged in an array, wherein the array of pins comprises a vacant site with no pin thereat, and at least three sites immediately adjacent to the vacant site are occupied by three of the plurality of pins, respectively; a connection port for connecting with at least a peripheral device; and a socket element electrically connected to the connection port, and comprising a plurality of holes arranged in an array, wherein the array of holes comprises a block site for receiving no pin therein, and the block site is in a position corresponding to the vacant site when the plug element is combined with the socket element.

Preferably, a size, more preferably as well as a distribution, of the array of pins is identical to that of the array of holes.

For example, the array of pins is a 2×5 array comprising nine pins and one the vacant site surrounded by three pins, and the array of holes is a 2×5 array comprising nine holes and one the block surrounded by three holes.

For example, the plug-socket connector is applied to a data-processing system is a personal computer (PC). The bus device is an IEEE 1394 serial bus compliant device, the control chip is an IEEE 1394 control chip, and the connection port is an IEEE 1394 port.

For another example, the plug-socket connector is applied to a data-processing system is a personal computer (PC). The bus device is a universal serial bus (USB) compliant device, the control chip is a USB control chip, and the connection port is a USB port.

### BRIEF DESCRIPTION OF THE DRAWINGS

The present invention may best be understood through the following description with reference to the accompanying drawings, in which:

FIG. 1(a) is a functional block diagram schematically showing a conventional plug-socket connector used for connecting a peripheral device to the main board of a personal computer (PC) system;

FIG. 1(b) is a perspective diagram schematically showing an exemplified structure of the conventional plug-socket connector of FIG. 1(a);

FIG. 1(c) is a schematic diagram schematically showing one of the possible mistakes occurring in the assembly of the plug-socket connector of FIG. 1(b);

FIG. 1(d) is a perspective diagram schematically showing another exemplified structure of the conventional plug-socket connector of FIG. 1(a), in which only the plug portion is shown; and

FIG. 2 is a perspective diagram schematically showing an exemplified structure of a preferred embodiment of the plug-socket connector according to the present invention.

### DETAILED DESCRIPTION OF THE INVENTION

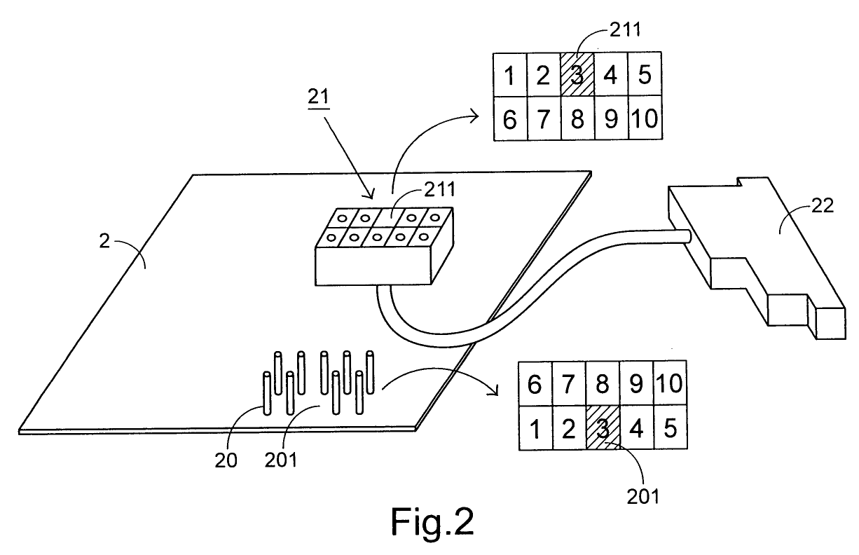

Please refer to FIG. 2, a preferred embodiment of the plug-socket connector applied to the IEEE 1394 control chip according to the present invention is shown. The plug 20 is mounted on the main board 2 and includes a 2×5 array of pins, while one of which is removed and substituted therefor by a vacant site 201. The vacant site 201 is arranged in the midst of the array and surrounded by three pins. The definition of the pins included in the array is described in Table 2. With reference to Table 2, the vacant site 201 is designated as “pin 3” in order to facilitate description of the array of pins. Pin 3 is surrounded by Pin 2, Pin 4, and Pin 8 in this embodiment. Certainly, the vacant site 201 can also be any other one of the pins except end pins such as Pin 1, Pin 5, Pin 6 and Pin 10. In other words, Pin 2, Pin 4, Pin 7, Pin 8, or Pin 9 can also be removed to serve as the vacant site 201 to achieve the object of the present invention.

TABLE 2

| | | | | | |
|---|---|---|---|---|---|
| pin | 6 | 7 | 8 | 9 | 10 |
| | PWR | TPA− | GND | TPB− | GND |
| | PWR | TPA+ | undefined | TPB+ | GND |
| pin | 1 | 2 | 3 | 4 | 5 |

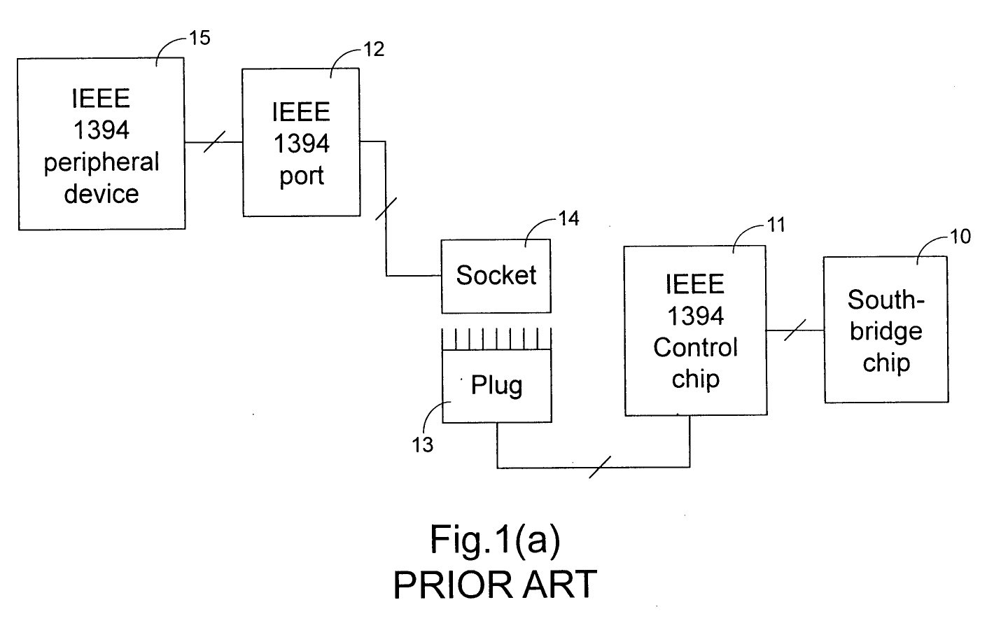

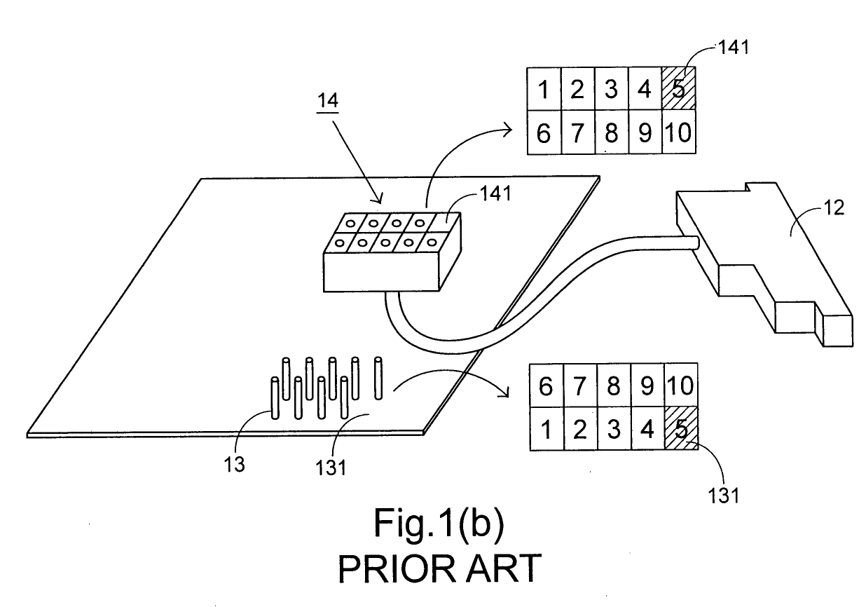

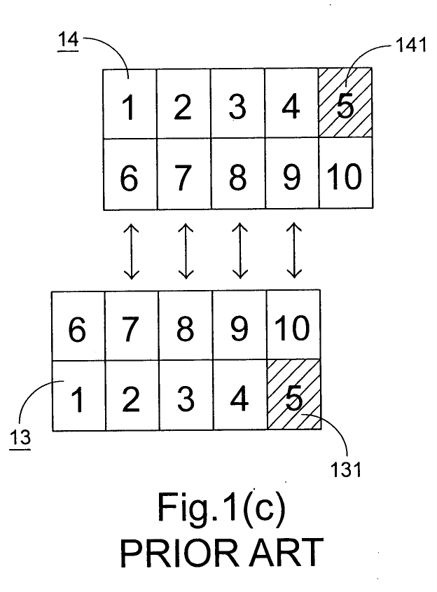

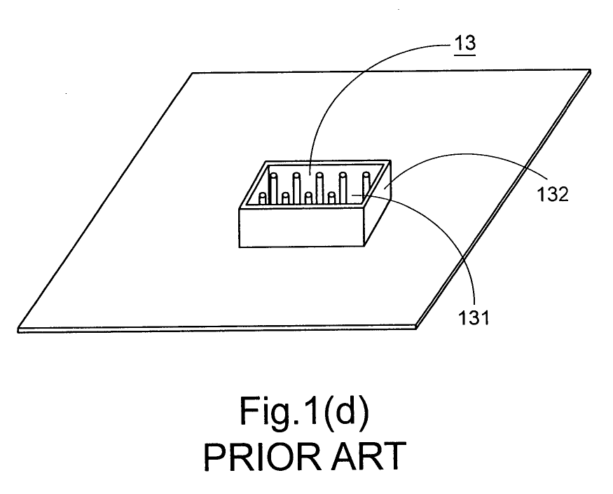

Likewise, the socket 21, which is electrically connected to the IEEE 1394 port 22, includes a 2×5 array of holes, while one of which is filled to become a block site 211. The block site 211 is arranged in the midst of the array and surrounded by three holes. The block site 211 is designated as one of the holes in order to facilitate description of the array of holes. Principally, the block site 211 can be any of the holes except end holes such as Hole 1, Hole 5, Hole 6 and Hole 10. In other words, Hole 2, Hole 3, Hole 4, Hole 7, Hole 8, or Hole 9 can also be filled to serve as the block site 211. The block site 211, however, has to correspond to the vacant site 201 of the plug element 20 when the plug-socket connector is assembled. By using the plug-socket connector according to the present invention, if the assembler carelessly sticks Pin 2 into the wrong hole 1 as in the situation shown in FIG. 1(c), Pin 4 will be blocked at Hole 3, i.e. the block site 211. Therefore, such mistake due to shift can be found immediately. Therefore, it is no way for the power voltage of 12V which is high enough to damage the IEEE 1394 control chip to be transmitted to the control chip.

Alternatively, the plug-socket connector according to the present invention can be used with the universal serial bus (USB). Certainly, the control chip will be a universal serial bus control chip, and the port will be a universal serial bus port.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A plug-socket connector for a bus device of a data-processing system, said bus device comprising a control chip mounted on a main board of said data-processing system, said plug-socket connector comprising:
a plug element mounted on said main board, and comprising a plurality of pins electrically connected to said control chip and arranged in an array, wherein said array of pins comprises a vacant site with no pin thereat, and at least three sites immediately adjacent to said vacant site are occupied by three of said plurality of pins, respectively;
a connection port for connecting with at least a peripheral device; and
a socket element electrically connected to said connection port, and comprising a plurality of holes arranged in an array, wherein said array of holes comprises a block site for receiving no pin therein, and said block site is in a position corresponding to said vacant site when said plug element is combined with said socket element.

2. The plug-socket connector according to claim 1 wherein said data-processing system is a personal computer (PC).

3. The plug-socket connector according to claim 1 wherein said bus device is an IEEE 1394 serial bus compliant device, said control chip is an IEEE 1394 control chip, and said connection port is an IEEE 1394 port.

4. The plug-socket connector according to claim 1 wherein a size of said array of pins is identical to that of said array of holes.

5. The plug-socket connector according to claim 1 wherein a distribution of said array of pins is identical to that of said array of holes.

6. The plug-socket connector according to claim 1 wherein said array of pins is a 2×5 array comprising nine pins and one said vacant site surrounded by three pins.

7. The plug-socket connector according to claim 6 wherein said array of holes is a 2×5 array comprising nine holes and one said block surrounded by three holes.

8. The plug-socket connector according to claim 1 wherein said bus device is a universal serial bus (USB) compliant device, said control chip is a universal serial bus control chip, and said connection port is a universal serial bus port.
